(19) United States
(12) Patent Application Publication
(10) Pub. No.: US 2008/0069289 A1
(43) Pub. Date: Mar. 20, 2008

(54) Self-regulating nuclear power module

(76) Inventor: Otis G. Peterson, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(21) Appl. No.: 11/804,450

(22) Filed: May 17, 2007

Related U.S. Application Data
(63) Continuation-in-part of application No. 10/630,111, filed on Jul. 30, 2003, now abandoned.
Application No. 10/630,111 is a continuation-in-part of application No. 10/244,580, filed on Sep. 16, 2002, now abandoned.

(51) Int. Cl. G21C 1/01

(52) U.S. Cl. 376/243

(57) ABSTRACT

The present invention includes a nuclear fission reactor apparatus comprising a core open to an atmosphere containing a hydrogen or a hydrogen isotope material, said core consisting essentially of a powdered fissile metal hydride material that remains entirely within said core; a plurality of trays outside said core that store a non-fissile material thereon wherein said non-fissile material absorbs and desorbs said hydrogen isotope material based on said core's temperature; a means for heating and cooling said plurality of trays; and a means for extracting energy produced in said core.

### RELATED APPLICATIONS

This application is a continuation-in-part of application Ser. No. 10/630,111, filed Jul. 30, 2003, which is a continuation-in-part of application Ser. No. 10/244,580, filed Sep. 16, 2002.

### STATEMENT REGARDING FEDERAL RIGHTS

The United States government has rights in this invention pursuant to Contract No. DE-AC52-06NA25396 between the United States Department of Energy and Los Alamos National Security, LLC for the operation of Los Alamos National Laboratory.

### FIELD OF THE INVENTION

The present invention relates generally to nuclear power sources, and, more particularly, to nuclear fission power reactors.

### BACKGROUND OF THE INVENTION

It has long been recognized that the use of a fissile metal hydride, such as uranium hydride, as a combined nuclear fuel and neutron energy moderator could potentially contribute to the stability of nuclear power modules because the hydrogen isotope's volatility contributes to neutron energy moderation. It has not previously been understood, however, that the basic characteristics of the hydride provide sufficient control of the nuclear reaction thereby removing the need for external controls, such as neutron absorbing rods, to stabilize the nuclear reactor.

The present invention provides a compact reactor using such hydride characteristics to control and utilize nuclear fission energy in a new and different manner then previously attempted. A compact reactor can be economical and practical only if it requires little or no active human control or monitoring, which is possible only if it is self-stabilizing. This present invention achieves nuclear fission control by utilizing the properties of a fissile metal hydride as long as the reactor physical size, the hydride powder particle size, and fissile metal content and enrichment are appropriately selected. In addition, the operating temperature must be selected to be high enough that the gas pressure is sufficient to achieve effective gas transport but not so high that the hydride powder particles fuse together to form macroscopic masses. With sufficient over-pressure of hydrogen, the metal will absorb ambient hydrogen, which moderates the neutron energies so that nuclear fission criticality is achieved. The temperature will then be increased by the fission reactions until the dissociation pressure of the hydrogen for that temperature is greater than the ambient pressure of the hydrogen, at which point the hydrogen dissociates from the hydride and the source becomes sub-critical. The reactor then becomes a relaxation oscillator in temperature and hydrogen content, which rapidly damps out into steady state operation. The dissociation pressure of the hydrogen is an exponential function of temperature, so small changes in temperature can initiate substantial hydrogen transport. Consequently, the method and apparatus of the invention achieve a dynamic equilibrium where the ambient hydrogen pressure controls the temperature of the power source.

### SUMMARY OF THE INVENTION

The present invention includes a nuclear fission reactor apparatus comprising a core open to an atmosphere containing a hydrogen or a hydrogen isotope material, said core consisting essentially of a powdered fissile metal hydride material that remains entirely within said core; a plurality of trays outside said core that store a non-fissile material thereon wherein said non-fissile material absorbs and desorbs said hydrogen isotope material based on said core's temperature; a means for heating and cooling said plurality of trays; and a means for extracting energy produced in said core.

### BRIEF DESCRIPTION OF THE DRAWINGS

FIG. 1 is a pictorial representation of one embodiment of the present invention.

FIG. 2 is a pictorial illustration of one embodiment of a containment system of the present invention.

FIG. 3 is a graph of the relationship between K_{eff} and hydrogen content.

FIG. 4a is a graph of the power transient for a temperature change of 5° C./min.

FIG. 4b is a graph of the power transient for a temperature change of 50° C./min.

FIG. 5 is a graph of the dissociation pressure in atmospheres for uranium hydride as a function of temperature.

FIG. 6 is a graph of critical mass of U²³⁵ spherical and cylindrical geometries as a function of the H/U²³⁵ atomic ratio.

FIG. 7 is a graph of the time dependence of diffusion-controlled depletion of hydrogen from uranium hydride particles.

FIG. 8a is a graph of power decay if the entire core is uranium hydride.

FIG. 8b is a graph of power decay if 10% of the core is uranium hydride.

### DETAILED DESCRIPTION

The present invention is a nuclear power reactor that is a dramatic departure from conventional reactor designs. The present invention is based on and takes advantage of the physical properties of a fissile metal hydride, such as uranium hydride, which serves as a combination fuel and moderator. The invention is self-stabilizing and requires no moving mechanical components to control nuclear criticality. In contrast with customary designs, the control of the nuclear activity is achieved through the temperature driven mobility of the hydrogen isotope contained in the hydride. If the core temperature increases above a set point, the hydrogen isotope dissociates from the hydride and escapes out of the core, the moderation drops, and the power production decreases. If the core temperature drops, the hydrogen isotope is again associated by the fissile metal hydride and the process is reversed.

The invention provides a novel technique for power generation and can compliment existing commercial power nuclear reactors. Extensive deployment of small nuclear power modules according to the invention can substantially improve our national energy independence. Each such unit would preferably generate modest thermal power (tens of megawatts) per unit and operate at a maximum fuel temperature ranging between 450° C. and 800° C. Preferably, the operating temperature will be in the range between 500° C. to 550° C. Such nuclear power modules would be inherently fail-safe from over-temperature excursions and may be mass-produced as turnkey modules due to inherent design simplicity and compactness.

Of the difficulties nuclear energy has faced as an alternative to fossil fuels, primary among these have been high construction costs and safety related uncertainties associated with complex active control and safety systems. The present invention provides an alternative enabling power generation from compact sources at modest unit costs. The small size of the device limits investment risk, and the inherent control and safety characteristics, as well as inherent simplicity, allow the power modules of the invention to be economically competitive for commercial power generation. Small size (approximately one or two meters in diameter) and the absence of mechanical intrusions permit a device according to the invention to be sealed at the factory, sited underground, and eventually returned to the factory after a useful life of five or more years. Single unit, sealed construction, and dispersed, underground siting also affords a significant level of anti-tampering and anti-terrorist protection.

Overall System Design

The reactor size has been evaluated by assuming that the core volume is equally divided between fuel and a means for extracting the energy produced in the core. In one embodiment the means for extracting the energy produced in the core are fluid conducting tubes. For example, the fluid conducting tubes could be energy extracting heat pipes (or cooling pipes). A system designed to generate useful power will require efficient extraction of the heat energy out of the system and therefore require a significant volume of pipes protruding into the fissile volume. The quantity and density of energy extracting heat pipes is determined by the low thermal conductivity of the hydrogen isotope/fissile metal hydride mixture. This dilution of the fissile volume will increase the critical mass and volume necessary to sustain power production.

The reactor size is also affected by the enrichment of the fuel, with higher enrichments yielding smaller reactors. The optimum size will depend on economic and engineering considerations. The fissile hydride, in the most common embodiment, will be diluted with a fertile hydride, often composed of the same element as the fissile component, but of a different isotope. For example, a nuclear fuel comprising the fissile hydride U²³⁵ typically also contains the isotope U²³⁸. A nuclear fuel consisting of 5% U²³⁵ and 95% U²³⁸ is commonly referred to as a “reactor grade fuel”.

The power modules of the invention are based on the properties of a fissile metal hydride, hereinafter referred to as uranium hydride (UH₃) or hydride; specifically, the ease with which a hydrogen isotope, hereinafter referred to as hydrogen, can move in and out of the hydride. The device is self-stabilizing and requires no moving mechanical components to control nuclear criticality. This passive control is achieved by exploiting the mobility of the hydrogen within and out of the uranium hydride. Although uranium hydride has been demonstrated as a reactor fuel (G. A. Linenberger, et al., “Enriched-Uranium Hydride Critical Assemblies”, Nucl. Sci. & Eng. 7, 44-57 (1960)), it has not previously been known to exploit the volatility of the hydrogen as a control mechanism for the fission activity.

The characteristics of uranium hydride that make it an ideal combination of fuel and moderator for a stable nuclear power source include: high density storage of hydrogen in the hydride matrix; powder formation as the hydride is formed from the metal; high diffusivity of the hydrogen through the hydride particles; multi-atmosphere dissociation pressures at power source operating temperatures to assist in heat and gas transport; exponential dependence of the dissociation pressure on temperature to drive the hydrogen volatility; and low viscosity of the gas.

The hydride stores vast quantities of hydrogen. For example, the density of hydrogen in a given volume of hydride is equivalent to the density of hydrogen in the same volume of water. This hydride hydrogen, however, is volatile and easily dissociates from the uranium and diffuses out of the hydride by any increase in temperature. The resulting decrease in moderator density effectively inserts negative reactivity into the core. A decrease in core temperature reverses the process (i.e., causes hydrogen absorption), increases the moderator density, and thereby inserts positive reactivity into the core. The customary control of nuclear power devices by the mechanical insertion (removal) of control rods is thus replaced by the self-regulating, temperature-driven desorption (absorption) of the moderating hydrogen. The complex arrays of detectors, analyzers, and control systems responsible for the safety and stability of conventional nuclear reactors are supplanted by the fundamental science and properties of the active materials in the present invention.

The hydrogen that is expelled from the fissile active core requires high volume storage. This high volume storage is preferably another mass of metal that can be hydrided and that is essentially free of any possible fission activity. For a uranium hydride reactor, the preferable storage medium for the hydrogen would be depleted uranium because depleted uranium is essentially fissile activity free and has identical chemical characteristics with respect to the active core hydride. The temperature of the deleted uranium storage medium would be controlled by external means and that temperature would, in turn, control the temperature of the fissile active core. The temperature control of the storage medium requires capabilities for both heating and cooling. The temperature preferably would be adjusted by means of some form of fluid flow such as heat pipes or non-hydrogenous fluid conducting pipes.

The device is a relaxation oscillator in temperature and hydrogen content that rapidly damps out into steady state operation. The hydrogen gas oscillates back and forth between the core and the non-fissile storage medium. The gas transport is driven by temperature oscillations of the core, but those temperature fluxuations are determined by the hydrogen concentration within the core.

Effective gas transport for reactivity control requires the unit volumes to be small. Even at this small size, however, these modules may be economically competitive because their inherent safety and stability may permit simplified system engineering, autonomous operation, and the mass production of turnkey devices.

Metal hydrides, including uranium hydride, are unusual compounds that can exist with a continuous range of hydrogen-to-metal atom ratios up to the stoichiometric value for the compound (i.e., 3 to 1 for UH₃). An advantage inherent to the hydride, in addition to the high density storage of hydrogen and powder formation as the hydride is formed, includes stability of the powder phase up to high temperatures (900° C.) (John F. Laker, “Isotherms for the U-UH3-H2 System at Temperatures of 700°-1050° C. and Pressures to 137.9 Mpa”, University of California Radiation Laboratory (UCRL)-51865 (1975)). The powder formed by hydrogen absorption into metallic uranium has a measured density of 7.5 gm/cm³ (G. A. Linenberger et al., “Enriched-Uranium Hydride Critical Assemblies”, Nucl. Sci. & Eng. 7, 44-57 (1960)) and is comprised of particulates that are less than 75 microns in diameter (James S. Church, “Uranium Hydride Fabrication”, Los Alamos Manuscript (LAMS)-872, Quarterly Report (Mar. 15, 1949)).

The small size of the hydride particles permits the hydrogen to diffuse out of the hydride particles very rapidly. The diffusion time constant was calculated numerically for the largest particle observed, 75-microns, and found to be approximately 30 to 40 milliseconds. In addition to such advantageous physical characteristics, the compound is also highly reducing chemically: a dramatic departure from commonly used nuclear fuels. This unusual chemistry can make fuel reprocessing and actinide recovery as straightforward as a few zone-refining runs.

A critical mass of the hydride fuel composed of reactor grade uranium (5% enriched in U²³⁵) has been evaluated from literature data and by running the Monte Carlo neutron transport code, MCNP (see J. F. Briesmeister, Ed., “MCNP-A General Monte Carlo N-Particle Transport Code”, Version 4C, Code Manual LA-13709-M, Los Alamos National Laboratory (2000)). The physical characteristics of a simple, nearly-spherical, critical mass are listed in Table 1 under the “Bare Core” column. The characteristics of a practical device in which one half of the volume contains heat pipe material and the other half contains hydride fuel is listed under the “Half Heat Pipes” column.

TABLE 1

| | | |
|---|---|---|
| Core Property | Bare Core | Half Heat Pipes |

| U²³⁵ enrichment | 4.94% | | 5% | |
|---|---|---|---|---|
| Final enrichment | 4.94% | | 3.5% | |
| UH₃ powder density | 7.5 | g/cm³ | 7.5 | g/cm³ |
| Void fraction | 0.32 | | 0.32 | |
| U²³⁵ critical mass | 30 | kg | 440 | kg |
| Total critical mass | 607 | kg | 8.8 | MT |
| Critical volume | 83 | liters | 2400 | liters |
| Critical diameter | 54 | cm | 1.44 | m |

| | | | |
|---|---|---|---|
| Energy content | Zero | 340 | MW years |
| Electrical power | Zero | 27 | MW |

| | | |
|---|---|---|
| Number of Heat Pipes | Zero | 1660 |

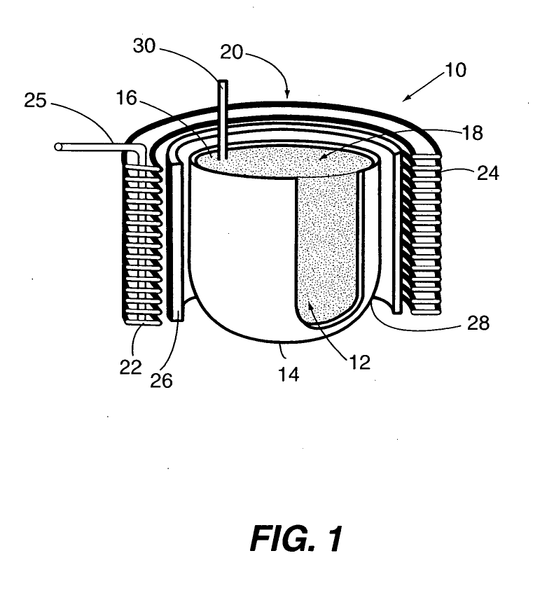

FIG. 1 is a pictorial illustration of one embodiment of the present invention reactor 10, which shows power module core 12 to consist of a vessel 28 with a hemispherical shape on the bottom 14 and a cylindrical shape 16 of equal diameter on the top. This vessel contains a powdered fissile hydride, which has protruding into it a plurality of cooling tubes of which 30 is a single example. Top surface 18 of the powder is approximately flat and open to hydrogen atmosphere 20, which allows the hydrogen to flow in and out of power module 12.

Also diagrammed outside core 12 is a collection of trays 22 to hold or store nonfissile hydrogen absorbing material 24 (preferably a nonfissile isotope of the core hydride) to absorb the hydrogen expelled from the core. The preferred storage material is depleted uranium whose chemistry is substantially identical to the fissile material or, alternatively, thorium because it is another actinide that is chemically similar and has a hydride dissociation pressure close to that of the fissile uranium. The reactor and hydrogen storage volumes are separated by insulator/neutron reflector 26 to dampen thermal feedback, as well as reduce neutron leakage.

The insulator/neutron reflector 26 is placed between the core and the storage media so that it can protect the trays from being heated by the core by either radiative heating or convective heating by means of the gas within the chamber. In one embodiment the insulator/reflector could be a hollow cylindrical vessel made of 316 stainless steel that is evacuated. In another embodiment the insulator/reflector could be a small number of concentric cylinders made of thin metal such as stainless steel.

The neutron reflecting properties of the insulator/neutron reflector are a secondary function because the core vessel 28 performs the primary neutron reflection function. The requirements for effective neutron reflection are that the mass of the nuclei within the insulator/reflector be equal or higher than that of the neutron. The neutron has a mass of one, so the entire periodic table is suitable for this function.

The temperature of the storage media, which is adjusted by thermal conductor 25, determines the hydrogen pressure within the sealed chamber by either absorbing or desorbing the gas. The ambient hydrogen pressure, in turn, fixes the effective temperature of the core by causing absorption of hydrogen by the core if the core temperature is below the dissociation temperature for that pressure, or causing dissociation and diffusion of hydrogen away from the core if the core temperature is above the dissociation temperature for that pressure.

Under normal operating conditions, startup procedures for the power module include employing temperature controllers (not shown but connected to the storage media by thermal conductor 25) for raising the temperature of the hydrogen storage trays to dissociate stored hydrogen from the storage media for absorption by the core. When the concentration of hydrogen in the core reaches the critical value, the reactor will generate fission energy and the core will rapidly increase in temperature. As the core temperature passes the storage temperature, the flow of hydrogen reverses and the core temperature oscillates for a short time before stabilizing. Similarly, the system can be shut down by cooling these trays so the storage media will absorb hydrogen, which effectively extracts hydrogen from the core. The core temperature is thereby fixed in value independent of the power extraction, allowing for beneficial load following characteristics, an obvious system advantage.

There are many configurations for controlling the temperature of the trays of hydrogen storage hydride material. These include elongated structures, for example heat pipes 25 illustrated in FIG. 1, installed for this explicit purpose and fluid flow systems. It would not be appropriate to use any hydrogenous fluid (e.g., water) to transport the heat within either the power conducting tubes 30 or the temperature controlling tubes 25 because of the necessity to prevent such fluids leaking into the reactor chamber and increasing the quantity of hydrogen therein. In one embodiment the nonhydrogenous-fluid is a liquid metal, however inert or noble gases could also be used. The preferred liquid metals for heat transfer include sodium, potassium, and their mixture, NaK. Atomic or noble gases could also be employed, preferably helium or argon. Molecular gases, such as nitrogen or carbon dioxide, have higher heat capacities than atomic gases and could also be employed. The heating and cooling of the trays of hydrogen storage material control the reactor. The cooling capacity must be sufficient to remove the chemical energy released by the absorption of the hydrogen into the storage media. Again, the preferred method of heating and cooling the trays would be heat pipes because of their passive operation. In this case, the preferred orientation would be horizontal to facilitate the transport of heat in both directions, as required to both heat and cool the trays. Outside the reactor the fluid conducting tubes would be thermally connected to other heat conducting media that ultimately lead to the surface where a temperature control apparatus can be applied. In one embodiment the temperature controllers would be industry standard and would insure that the temperature of the trays would be kept essentially constant except for minor adjustments to accommodate variations in power loading. In one embodiment, heat is extracted from the fissile volume with liquid metal heat pipes or nonhydrogenous-fluid cooling tubes. A single exemplary heat pipe 30 is illustrated in FIG. 1. The use of liquid metal heat pipes (e.g., alkali metal such as sodium or potassium) contributes to the system's passive safety by eliminating the need for mechanical pumps (and the concomitant potential for mechanical failure of such pumps) to transport the thermal energy out of the fuel. The liquid metal does not introduce any non-volatile moderation, as would water-cooling. Further, the heat pipes can be designed to provide suitable redundancy and overcapacity in addition to fail-safe cooling to dissipate energy generated by the decay of radioactive fission products. An actively pumped cooling system employing a nonhydrogenous fluid would be equally effective in implementing the transfer of heat from the core to a heat exchanger for subsequent generation of electricity. The active system would preferably have redundant pumping capacity to insure cooling continuity.

Heat pipes operate effectively up to lengths that are limited by the aspect ratio (ratio of length to diameter) of the devices of about 100 to 1. In one embodiment these pipes are standard 1 inch diameter tubes made of 316 stainless steel and containing a stainless steel screen positioned along the inside diameter of the pipe to act as a wick for the potassium working fluid. These pipes could be mass-produced to save costs and insure excellent quality control.

The heat pipe cooling system, as described above, is adequate for almost all contingencies. To manage the possibility that the primary cooling system might fail, a secondary cooling capability may be provided to extract from the heat pipes the power produced by the radioactive decay energy stored in fission fragments. Such radioactive decay energy starts at 7% of the operating power of the reactor but rapidly decays from that value. A conservative approach to total system safety may motivate the installation of an independent cooling system for the “pot” that contains the hydride. This third level of heat extraction would protect the uranium container from any possibility of catastrophic damage that may be envisioned if the stored energy could raise the powder temperature to the melting temperature of uranium metal.

There are several choices for alternate cooling or energy extraction systems instead of the proposed heat pipes that might afford equivalent or possibly even greater benefits. These include active fluid flow systems of liquid metals or, alternatively, inert or noble gases, atomic or molecular. The important selection criterion is that any coolant fluid be non-hydrogenous so as not to add any nonvolatile neutron energy moderation to the system. An additional constraint is the use of a fluid with minimal neutron absorption so as not to increase the critical mass of the reactor. The preferred liquid metals for heat transfer include sodium, potassium, and their mixture, NaK. Atomic or noble gases could also be employed, preferably helium or argon. Molecular gases, such as nitrogen or carbon dioxide, have higher heat capacities than atomic gases and could also be employed. Essentially all of these fluids have been effectively employed in reactors at some time.

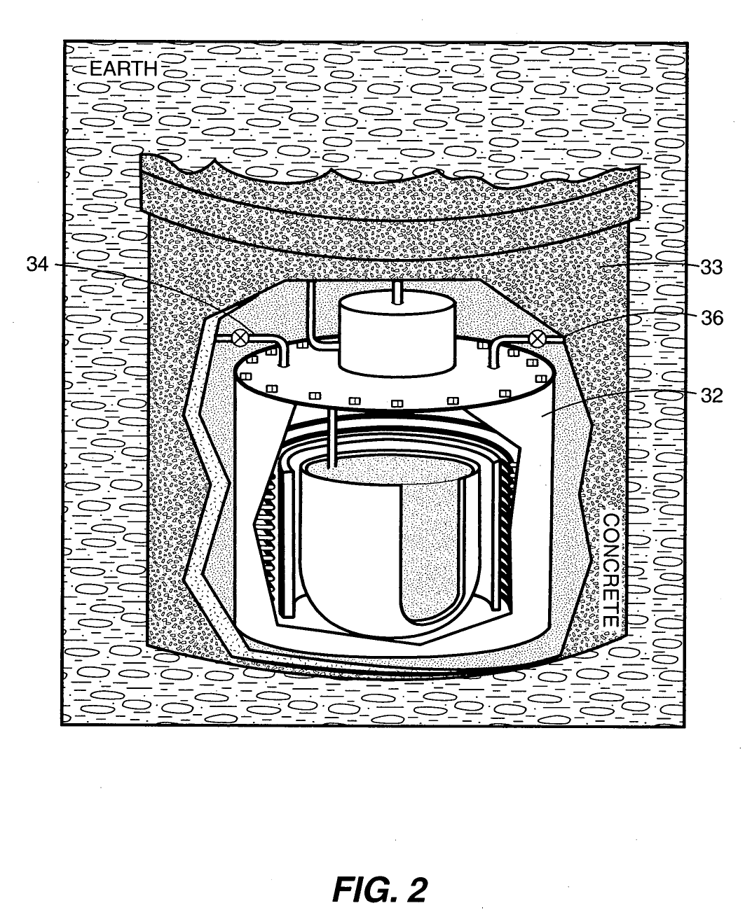

FIG. 2 further illustrates the outside containment vessel 32, that confines the hydrogen gas, and underground vault 33 that provides shielding for the external environment. This containment vessel is preferably sealed at the factory except for a plurality of small gas ports 34, 36. Such gas ports allow for pressurization/depressurization of the vessel with hydrogen and permits periodic maintenance of any contained gases. Fission product gases (non-essential reactor byproduct gases), such as neutron absorbing (fission poison) Xenon and other fission fragment gases, can be removed and hydrogen added to replace hydrogen that is lost to diffusion out of the container. The gas maintenance function will preferably take advantage of the hydrogen absorption or hydrogen transmission characteristics of certain metals to separate the hydrogen from the other elemental impurities. Also, the power module can be made completely safe from inadvertent nuclear startup by evacuating most of the hydrogen out of the chamber through these ports thereby removing the moderation required for criticality. Moreover, it should be noted that the gas is a nominally fixed volume with only minor adjustments in quantity and composition.

Because of the compact design, the entire reactor module and containment vessel can be designed for removal from the vault and return to the factory at the end of its useful life. In such a scenario, it is preferred that the reactor vault and shielding be a permanent structure, such that only the power module and its containment vessel are replaced. Because of the small size of the module, it is expected that the vault containing the module will be sited underground so that most of the radiation shielding will be the local earth. The low cost of the shielding is another economic advantage of this invention.

Reactor Core Design

Neutron multiplication in the module is regulated by a highly sensitive moderator feedback coefficient. An initially positive reactor period can be rapidly reduced by the hydrogen bubbling out of the core, desorbed from the particles due to the rise in temperature. However, the recovery from a negative reactor period must be more gradual due to the slower pressure-induced transport of the hydrogen into the powder for its re-absorption into the particles. Therefore, a dynamic equilibrium of the core criticality can damp out after a small number of oscillations.

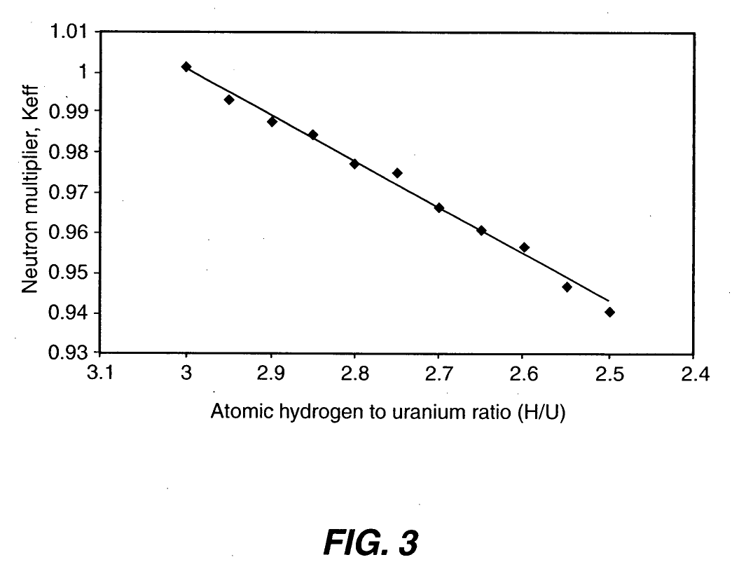

The MCNP code was employed to quantitatively evaluate the reduction in the neutron multiplication factor, K_{eff}, by the loss of moderation due to hydrogen depletion. This code was used to determine the functional relationship between K_{eff} and the hydrogen content because the function was not found in the experimental research literature. Experiments are customarily performed with a constant density moderator, water, and variable densities of fuel instead of the opposite as required for this application. This multiplication factor, K_{eff}, was evaluated and found to change about 3.4%, equivalent to about $4.70 of negative reactivity, when the hydrogen density dropped 10%. The functionality is displayed in FIG. 3, which also shows the individual points that were calculated to determine the function. This calculation was simplified by assuming that the hydrogen was uniformly depleted throughout the core.

Under normal operation the control of the criticality of the reactor requires hydrogen mobility that is equivalent to the depletion of only a few tenths of a percent, which is equivalent to a few millimeters of hydride in a one-meter core. The change in hydrogen content of 0.03% translates into a change in the value of the neutron multiplier, K_{eff}, by one part in 10⁻⁴.

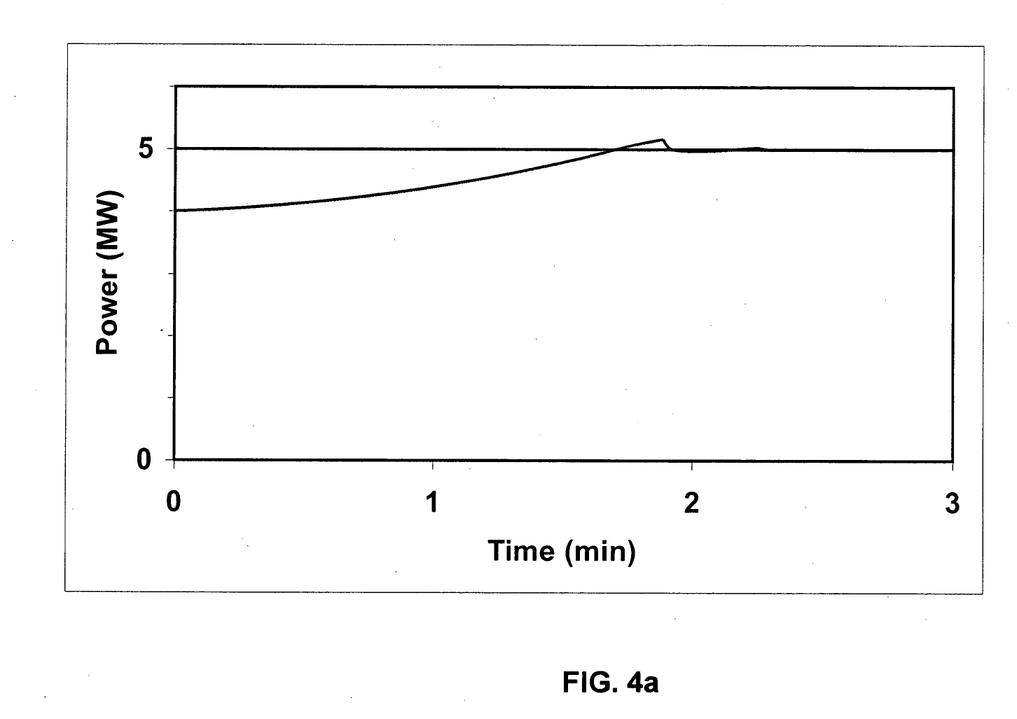

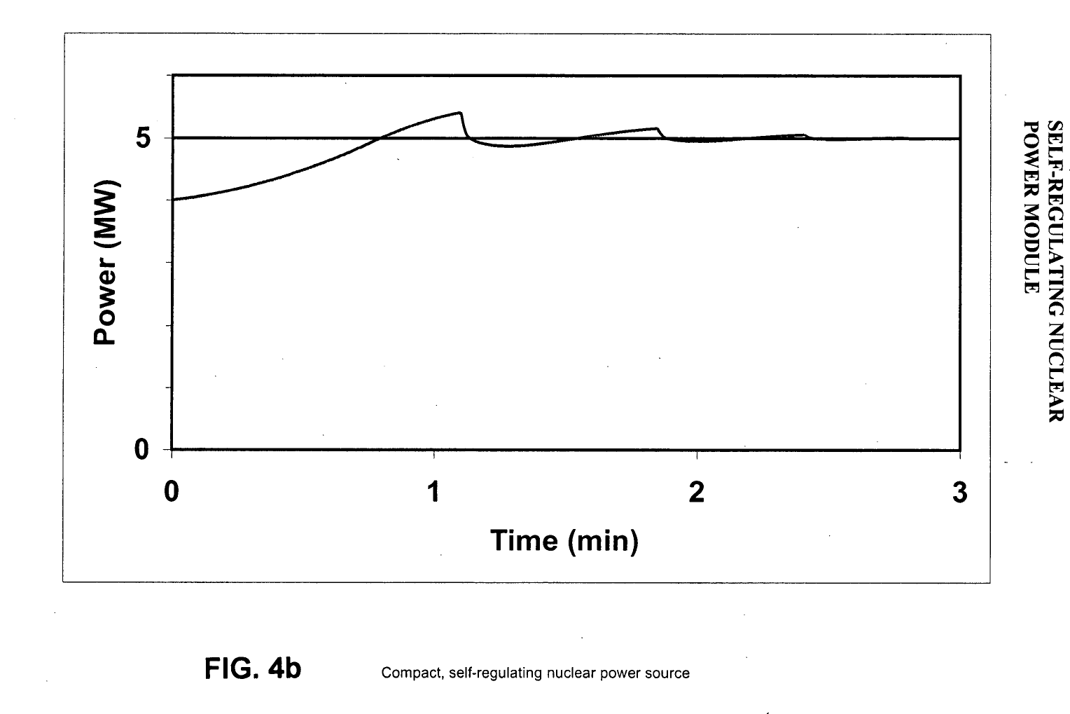

Although a positive reactor period can be rapidly reduced by the hydrogen desorbing and bubbling out of the core, the recovery from a negative reactor period (rate of neutron decrease) must be more gradual due to the slower pressure induced transport of the hydrogen into the powder volume. Referring to FIGS. 4a and 4b, results of numerical model calculations indicate that the initial response of the reactor to power transients will be mild oscillations that dampen out under proper conditions.

The effective steady-state temperature of the core is controlled by the ambient hydrogen gas pressure, which is controlled by the temperature at which the nonfissile hydrogen absorbing/desorbing material is maintained. The temperature of the fissile volume therefore is independent of the amount of power being extracted (load following). The power output is dependent only on the ability of the heat pipes and heat exchanger to extract the power from the module.

There are several characteristics inherent to uranium hydride that contribute to the stability of reactors based on this material. The high mobility of the hydrogen, both within the hydride and throughout the active volume, creates the system stability. The addition of hydrogen to uranium metal makes it very brittle and the material rapidly turns to powder. Furthermore, this powder is stable, not fusing together until over 900° C. (John F. Lakner, “Isotherms for the U-UH₃-H₂ System at Temperatures of 700°-1050° C. and Pressures to 137.9 MPa”, UCRL-51865 (1975)). The small size of the particles is advantageous because it permits rapid diffusion of the hydrogen out of the particles and therefore rapid response of the reactor to changes in temperature. Most of the gas is expected to escape from the volume by fluidizing the powder and ultimately pushing the powder aside and bubbling through the powder to the surface. As noted earlier, the diffusion rate out of a single large particle has been evaluated for the experimentally measured maximum particle size (75 microns in diameter) and found to be approximately 30 to 40 milli-seconds.

The temporal response of any nuclear reactor is controlled by the relatively long lifetimes of the small fraction of delayed neutrons that are emitted by the fission products. The termination of nuclear activity, as necessary to control the system temperature, is dependent on the rate at which this delayed neutron emission decays and the rate at which the system criticality can be reduced. Each of these phenomena that affect the stability of the system has been evaluated quantitatively but within the context of an example critical assembly.

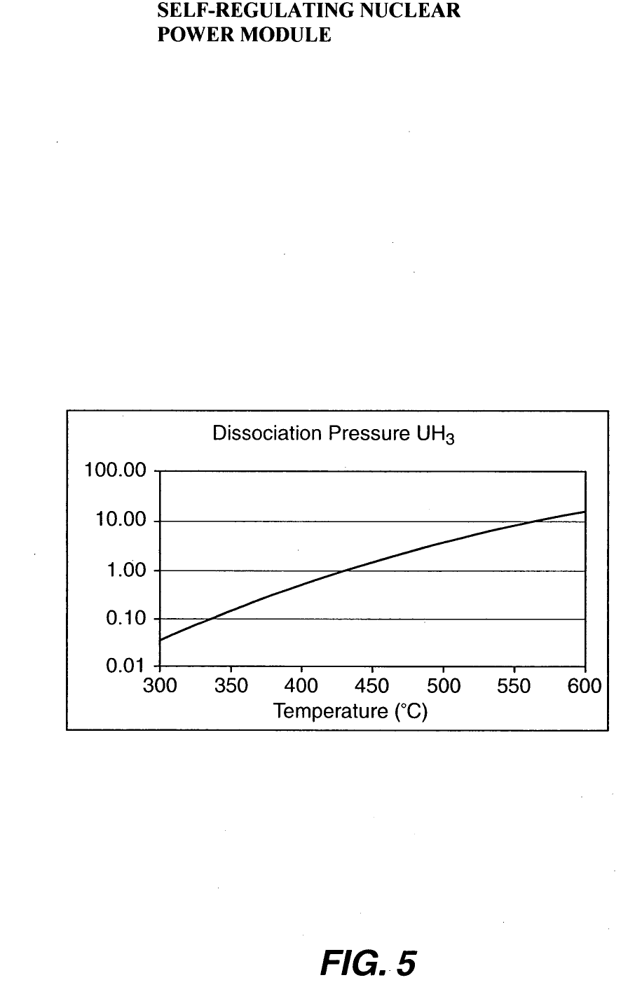

The invention is limited in operation to the temperature range from approximately 400° C. to 800° C. for UH₃ based fuel, where the dissociation pressure of the hydride is in the range that permits efficient gas transport (see FIG. 5). The data comes from “The H-U System,” Bulletin of Alloy Phase Diagrams, 1, No. 2 (1980), pp. 99-106. This temperature range is fortuitous because it includes the near optimum temperature for operation of steam boilers which is in the mid-500° C. range (Samuel Glasstone, Principles of Nuclear Reactor Engineering, D. Van Nostrand Co. (1955), §1.24). The temperature limits are not hard limits but are approximations based on practical considerations. The lower limit is only slightly less than the temperature at which the dissociation pressure of UH3 is equal to atmospheric pressure (430° C.). That limit is a practical one because temperature gradients necessary to extract power would force the chamber pressure to be over atmospheric. As long as the chamber gas pressure is over atmospheric, any gas leaks that might occur would only deplete the hydrogen in the reactor chamber and not allow any atmospheric oxygen to enter, which could cause potential hazards. The maximum temperature was selected so that any temperature gradients required for power extraction would not push any local temperatures over the point at which the UH3 starts to agglomerate into macroscopic masses with long hydrogen diffusion times. Within this overall range, the preferred operating temperature would be approximately between 500° C. to 550° C., which is near ideal for steam generation.

Although MCNP was used to evaluate the critical mass of the reactor configurations, these calculations were verified using the following scientific literature. H. C. Paxton et al. have compiled extensive data on uranium criticality, mostly from experiments using highly enriched uranium diluted with water moderator (“Critical Dimensions of Systems Containing U²³⁵, Pu²³⁹, and U²³³,” Los Alamos Scientific Laboratory and Oak Ridge National Laboratory Report TID-7028 (June 1964)).

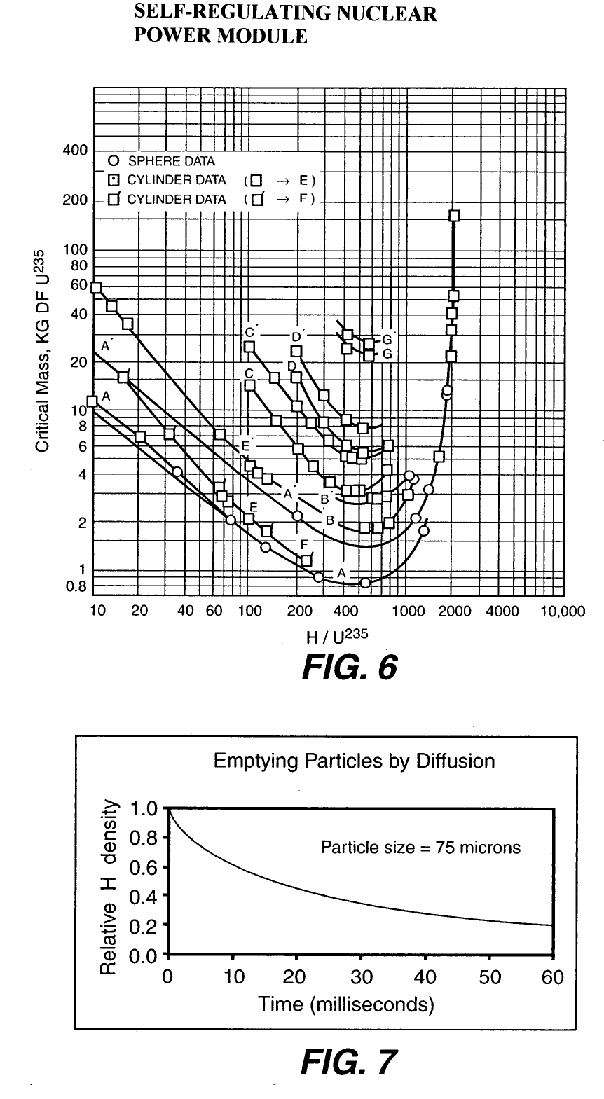

The critical mass has been evaluated as a function of the density of the fissile uranium 235 in a water moderator and is plotted as a function of the ratio of H to U²³⁵ for several values of enrichment in FIG. 13 of the reference, which is reproduced as FIG. 6 of the present application. All geometries include neutron reflectors, either water or paraffin; Curve A shows U(93)O₂F₂ solutions and U(95)F₄—CF₂—CH₂; B shows U(4.9)O₂F₂ solutions; C shows U₃(4.9)O₈—C₅₇H₂₁₀O₆; D shows U(2.0)F₄—C₂₅H₅₂; E shows U(37)O₂F₂ solutions and U(37)F₄—CF₂—C₅H₈O₂; F shows U(29.8)F₄—CF₂—CH₂; and G shows U(1.42)F₄—C₄₀H₈₁.

The “C” curve for 4.9% enriched uranium is the most appropriate for estimating the critical mass for this device. The line from 15 kg past 30 kg has been extrapolated from the published data and the critical mass for the hydride power source can be estimated from this extrapolation to be approximately 30 kg of U²³⁵ for the H to U²³⁵ ratio of 61, which is characteristic of UH₃ enriched to 4.9%. This value is approximately double the critical mass measured for 93% enriched uranium hydride (G. A. Linenberger et al., “Enriched-Uranium Hydride Critical Assemblies,” Nuclear Science and Engineering: 7, 44-57 (1960)).

The experiments by Linenberger et al. were performed on blocks of UH₃ that were fabricated from powdered UH₃ held together with a polymeric binder. Because the powder was bound up with the polymer, no experiments could be performed to investigate the self-stabilizing potential of the UH₃ powder, active material. The critical masses measured by Linenberger et al. were all approximately 13.6 kg of the 93% enriched uranium for assemblies using neutron reflectors to reduce the required mass. The factor-of-two difference between the masses of U²³⁵ required to achieve criticality depending on the enrichment of the active material is consistent with other data published in Paxton et al., supra.

The physical dimensions of a practical device will depend on many important engineering factors and can be purposely manipulated in many ways. The limited thermal conductivity of the fuel dictates a high density of heat extracting pipes or tubes. The fuel enrichment will significantly affect the core size, with greater enrichment decreasing the size and lesser enrichment increasing the size significantly. In addition, the isotopic content of the hydrogen gas can be manipulated to increase the size of the core. Deuterium is less effective at neutron energy moderation than is protium, therefore, adding deuterium to the gas will increase the required core size. This characteristic can also be employed to increase the useful lifetime of a single load of fuel by doing the initial moderation with a high concentration of deuterium and progressively replacing the deuterium with protium. In this manner, the decrease in fissionable material is counterbalanced by the increase in moderation effectiveness.

Neutron Flux Transient Response

The transient response of the reactor is dependent on the hydrogen content and its flow in and out of the reactor core. A period of positive reactivity with increasing power production will be terminated only after the power has overshot the value that can be extracted. The excess power that is produced will raise the temperature of the critical volume, which triggers the dissociation of the hydride into metal and hydrogen gas. The amount of energy required to dissociate all of the hydrogen in a volume of uranium hydride powder is 4.3 kJ/cm³. Thus, at an assumed reactor power production rate of 50 to 100 W/cm³, the time to deplete a given volume would be 43 to 86 seconds. During this time the temperature of the volume would be held approximately constant because the power would go into dissociating the molecules and not into heating the volume, similar to phase transitions.

A period of negative reactivity with decreasing power production will start as soon as enough hydride has been dissociated to reduce the K_{eff} below 1.0 (i.e., a condition less than critical). The period of negative reactivity will last until hydrogen has been forced into the core by external pressure to bring the moderation back up to critical (i.e., where K_{eff} is again 1). Under the right conditions this oscillatory behavior will continue for a short time before being damped out by the inherent disparity between the rates of inflow and escape of the hydrogen gas, as graphically shown in FIGS. 4a and 4b.

The numerical calculation for the neutron flux, and proportionately the reactor power, can be separated into several components within each time step and then repeated for each of these small time steps. It is assumed that the transient of concern is generated by a relatively rapid buildup of neutron flux as the reactor increases power production. The reactor power production is increased by extracting more heat from the core than is being generated. The extra heat extraction cools the core below its stable temperature as fixed by the ambient hydrogen gas pressure. A drop in core temperature will reduce the dissociation pressure within the core, driving more hydrogen into the reactor. The increase in hydrogen content increases K_{eff} according to the function presented above. This small increase in K_{eff} will increase the neutron flux and also the precursors for the delayed neutron production.

The critical equation for the neutron flux, φ, within a reactor is:
l dφ/dt=[K_{eff}(1−β)−1]φ+ΣᵢCᵢ/τᵢ
where l is the neutron lifetime, β is the total fraction of delayed neutrons that are emitted following fission, and Cᵢ is the effective concentration of fission products that emit delayed neutrons of decay time τᵢ (Samuel Glasstone, Principles of Nuclear Reactor Engineering, D. Van Nostrand Co. (1955)). For uranium²³⁵ the value of β is 0.73%. The effective values of the fission product concentrations can be evaluated from the following differential equation:
d Cᵢ/dt=βᵢφ−Cᵢ/τᵢ,
where βᵢ is the fraction of neutrons with the decay time of τᵢ. The decay lifetimes range from 0.33 to 81 seconds.

These coupled differential equations cannot be solved analytically in a simple form. However, if we make a few assumptions, they can be solved with a combination of analytical and numerical methods. A convenient size for a single numerical step is approximately one second or a fraction of a second. The ratio of the neutron lifetime, approximately 7 microseconds, to the time step is then about 10⁻⁴. The change in the neutron flux over the time step is also small, so the differential term in the equation can be ignored and the neutron flux approximated by the following equation:

$$φ = \frac{1}{1 - {K}_{eff} ( 1 - β )} {\sum }_{i} {C}_{i} ( t ) / {τ}_{i}$$

For each step in the numerical calculation the populations of each precursor family is calculated assuming the neutron flux has the constant value it had at the beginning of the time step. A new value for the neutron flux is then calculated from these population values. Other system parameters are then calculated from this flux or from independent inputs. The other important parameters include gas flow characteristics, hydrogen content within the core, and core temperature and hydrogen pressure. The K_{eff} in these equations is evaluated from the hydrogen content using the MCNP calculations described above. The cycle of calculations is repeated as many as a thousand times to predict the temporal behavior of the reactor.

Hydrogen Transport

Under normal operating conditions only a fraction of a percent of the hydrogen stored within the core will be exchanged between the core and storage media to maintain equilibrium. If the system temperature starts to rise because of a sudden decrease in power extraction, including catastrophic coolant failure, the escaping hydrogen will push the powder aside and bubble up to the surface. The gas will ultimately bubble out because the gravitational pressure head of powder is less than the pressure required to force gas flow through powder. At the very first, a depletion wave will start on the top surface of the powder and progress down through the volume. Above the front of this wave, the rate of hydrogen depletion will be limited by the diffusion of the gas out of the hydride particles. Below the front of this wave the weight of the particles will maintain the gas at the dissociation pressure and prevent gas from escaping from that volume.

Following this initial transient, the rate at which the gas is driven out of the core will be limited by the fission power being produced that is in excess of what can be dissipated by the heat pipes. The power required to dissociate the hydride is 4.3 kJ/cm³. The power driven gas evolution will be volumetric but all of this gas must escape out of the top surface. The volumetric gas flow will linearly increase in the vertical direction. For large enough power transients this gas flow will exceed the threshold for fluidization of the powder at some position within the powder. Above this transition position, the powder density will be diminished and above that bubbles will form to transport the gas swiftly through the powder. For the purposes of the modeling calculations, it is assumed that the resistance to gas flow by the generation of bubbles is negligible.

The escaping hydrogen gas must have a large volume pathway to the storage medium to ensure a minimum pressure gradient to promote the flow. The storage material must be dispersed over a large number of trays to present a vast surface area to the gas volume to absorb the excess hydrogen in a time scale comparable to the bubble assisted escape from the core. The storage material would preferably have identical chemistry to the hydride in the core of the reactor, but must be essentially free of any fissile material. Fissile content within the storage material could internally heat the material because of the high neutron flux within the reactor chamber. Such internal heating could complicate the temperature controlling system. A preferred storage material that would be chemically compatible with the preferred uranium hydride core material would be depleted uranium. Depleted uranium is predominantly the U²³⁸ isotope, which is non-fissile and has been essentially depleted of the U²³⁵ fissile isotope.

Filling the core with hydrogen is a much slower process than the escape because the gas must be forced into the volume by pressure induced flow through powder. The disparity between these two phenomena is another significant advantage of uranium hydride because it can introduce damping into the transient behavior of the reactor. The reformation of the hydride requires a pressure differential to force the gas into the core. The replenishment of the hydride will start on the surface of the powdered fuel and proceed until the surface layer is saturated. The layer of saturation will then progress into the fuel volume. It is assumed that the initial escape of the gas left the hydride throughout the volume a few percent below saturation. The production of the hydride will then result in saturated hydride near the surface with the remaining volume slightly depleted.

To continue hydride production the gas must be transported across the saturated layer into the region of depleted hydride. The gas flow calculations require knowledge of the pressure difference across the saturated layer and the width of that layer. Using these parameters and the properties of the powder, the flow rate through the power can be calculated from the following equations (see I.E. Idelchik, “Handbook of Hydraulic Resistance”, 2^{nd} Ed., Hemisphere Publishing Corp. (1986)):

$$Δ P = ( \frac{{ρν}^{2}}{2} ) \frac{1.53}{{ɛ}^{4.2}} \frac{λ l}{d} , \\ where λ = \frac{75}{Re} + \frac{15}{\sqrt{Re}} + 1 , \\ and Re = \frac{0.45}{( 1 - ɛ ) \sqrt{ɛ}} \frac{ν d}{ν}$$

In these equations ΔP is the pressure head, ρ is the gas density, v is the gas velocity, ε is the void fraction (0.32) in the powder, l is the width of the saturated volume through which the gas must be forced into the core and d is the average particle size (6 micron). Re is the Reynolds number in which u is the viscosity of the hydrogen gas. For the purposes of the numerical calculations, the Reynolds number for one step in the calculation is used to evaluate the gas velocity within the next step and the Reynolds number subsequently updated.

During periods of negative reactivity, the heat extraction from the core can dramatically reduce the core temperature and therefore the gas pressure. A simple assumption of constant power extraction from the core would reduce the temperature and pressure to levels that are not physically believable. The technique for heat extraction that appears most attractive is alkali metal heat pipes. Such heat pipes do not contribute any non-volatile moderation to the core, as would be the case for any hydrogenous cooling fluid. Heat pipes have very distinct temperature dependent power transport properties. In the low temperature portion of their operating range, the transport is dependent on the vapor pressure of the working fluid. The power extraction increases with temperature up to a saturation level that is dependent on the sound velocity of the gaseous fluid. In the system modeling, this functionality of the heat pipes has been applied to the heat extraction to limit the range of temperature and pressure excursions to values more connected to reality. In one embodiment the alkali metal heat pipes are potassium.

In an example numerical simulation, the core temperature dropped about 40 or 50° C. and the core pressure dropped about 4 atmospheres from a starting pressure of 8 atmospheres. Such a pressure difference is certainly adequate for pushing the hydrogen into the core to regenerate the hydride required for moderation of the fission activity.

All of these considerations have assumed that the diffusion out of the hydride particles is rapid. The diffusion rate for the largest particles in the powder, 75 microns in diameter, has been calculated numerically using the best available value for the diffusion constant D=1.9×10⁻⁶exp(−5820/T) (m²/s). FIG. 7 shows the temporal decay of the hydrogen content in the 75-micron diameter particle. The relative concentration drops to the 1/e value in 33 milliseconds and the long-term decay time constant is 38 milliseconds. The conservative value for the diffusion time for the large particles was 40 milliseconds, which is three orders of magnitude faster than is required to supply the hydrogen gas expelled during a loss of coolant accident (shown below).

As discussed previously, it is anticipated that a compact reactor according to the invention will be assembled and fueled at a factory and shipped to its installation point as a sealed unit. During shipping inert gases will be introduced into the chamber to keep it pressured above atmospheric to prevent any leakage of oxygen into the chamber. After the final installation has been completed, the inert gas will be evacuated and the appropriate quantity of hydrogen admitted into the sealed chamber. The admission of the hydrogen is carefully controlled to insure that the correct quantity is admitted. Any overfilling of the chamber with hydrogen could defeat the inherent safety features of the reactor by saturating both the core and storage media. Preparatory to the return shipment of the reactor to the factory, the bulk of the hydrogen will be evacuated from the chamber and the chamber over-pressurized with inert gas to eliminate all possibilities for further nuclear reactions and to prevent the inadvertent admission of oxygen.

Simulation of a Reactor Transient

The transient response of the reactor can be evaluated within the assumptions and conditions discussed above. Initially the calculation assumed that the reactor without heat pipes was operating at a power level of 4 MW and the power extraction was increased to 5 MW. The initial transient response was calculated assuming that changes in the heat extraction were restricted so that the rates of temperature rise have a fixed value. FIGS. 4a and 4b show that the power builds slowly from its initial value, overshoots the new set point, but quickly turns around for two values of the fixed temperature rise rate: 5° C./min and 50° C./min. The transient generates oscillations that quickly damp out even for an order of magnitude change in rate of temperature rise. The period during which the power produced is in excess of the stable value is very short, and the over-excursion in power remains less than 10% of the stable value. The assumed rates of temperature rise are far more rapid than are ever expected of large-gigawatt power production facilities.

The power oscillations observed were caused by oscillations in the hydrogen concentration and resulting K_{eff}. In the case where these oscillations were rapidly damped, the oscillations in hydrogen content were found to change by less than a tenth of one percent and the resulting changes in K_{eff} reached a maximum of just over 2×10⁻⁴ at only one time during the simulation. The disparity between the length of time the system spends above and below the set point is due to the differences between the phenomena that control the gas flow in the two regions of operation.

Inherent Stability from Coolant Loss

To justify minimal operational oversight, the reactor must be demonstratively safe in the event of a worst-case accident: complete loss of coolant during full power operation. The response of the device to such circumstances has been modeled for the bare core without cooling tubes. A reasonable power production for the bare core reactor is 5 MW thermal. The effects of this sudden disappearance in cooling capacity have been evaluated numerically with the same rate equations as used above to calculate the transient response of the reactor. Applying the full power of the reactor to the dissociation of the hydride drives off large quantities of hydrogen in a short period of time. The consequent reduction in moderation depresses the neutron flux reducing power production and the rate of production of precursors for delayed neutron emission. The reactor is shut down in a very short period of time.

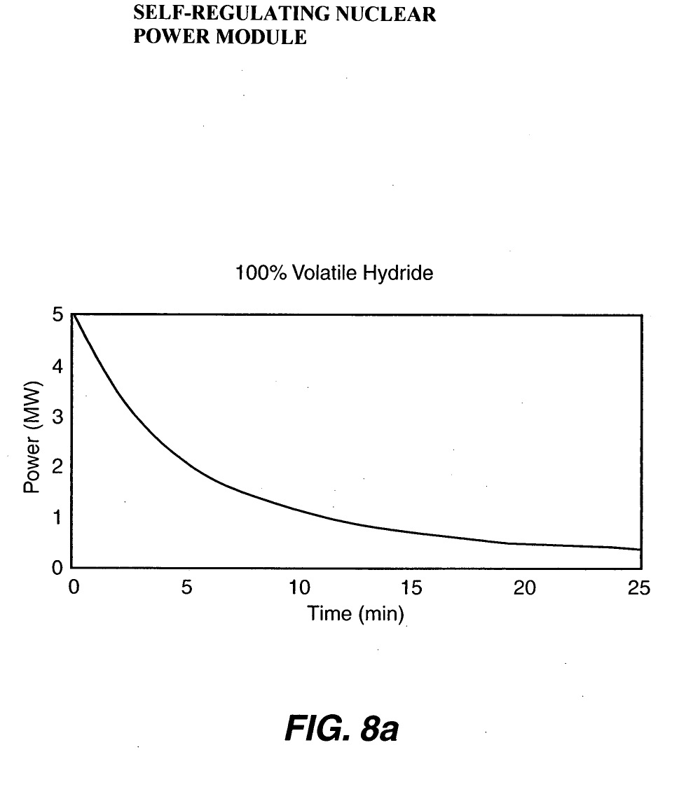

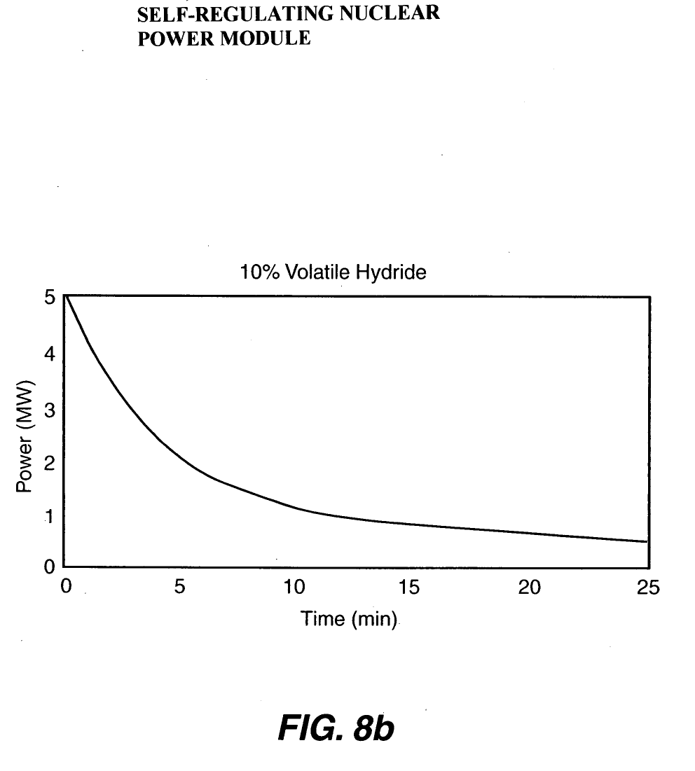

An attractive design would quench the fission power production down to the power production of the radioactive fission fragments before the hydride had been all dissociated. If the entire core is uranium hydride this criteria is satisfied as is shown by the power decay displayed in FIG. 8a. Artificially limiting the fraction of the core that is volatile demonstrates that almost equivalent results are obtained if at least 10% of the core is volatile hydride. The power curve for the 10% volatility case is shown in FIG. 8b. The two curves are remarkably similar. The conclusion is that reactor designs should allow for dissociating at least 10% of the hydride and have the capacity to absorb at least that quantity of released hydrogen.

Impurity Effects

There is a concern associated with impurities. There is a possibility of hydride powder particles fusing together, due to increased impurities as a result of fission byproduct elements lowering the overall melting temperature of the hydride. This would slow down the diffusion of hydrogen out of the hydride particle. An illustrative example is plutonium creation. Plutonium is created from U²³⁸ by the phenomenon of neutron capture. Because of plutonium's lower melting temperature than uranium, the hydride particle melting temperature will decrease as plutonium is created. However, the phase diagram for mixtures of uranium and plutonium have been well studied and the melting temperature of nearly pure uranium drops only 11° C. for each one percent of added plutonium. Such a small variation in melting temperature has no significant effect on the potential fusion of the particles. Because the fission fragments are statistically distributed over a number of elements, the concentration of any single element should never exceed 0.2%. Therefore, although impurities will be introduced, they will not have a detrimental effect on reactor operation within the temperature range of preferred operation.

Reactor Operation: Startup/Shutdown

Under normal operating conditions, the power module is started up from a standby or low power operation by raising the temperature of the hydrogen storage trays to drive stored hydrogen over to the core. Similarly, the system is shut down or put into standby by cooling these trays so they absorb hydrogen extracted from the core. Under equilibrium operation, the core temperature is slaved to the storage tray temperature. When the module is producing significant power, the storage tray temperatures must be raised significantly to keep hydrogen in the hydride volumes affected by the temperature gradients that extract power from the fuel. This characteristic generates an additional safety feature: the storage trays must be maintained at a temperature elevated above the average temperature of the fuel. This prevents the core from inadvertently heating the storage volume thereby releasing hydrogen and generating runaway fission.

The modules are initially started after installation at their operating site by the carefully monitored addition of hydrogen into the sealed chamber. This will generate the required hydride from the mixture of hydride and metallic powder already installed into the core during module manufacturing. To promote the hydride forming reaction, the core and storage trays may need to be raised to the 200° C. temperature region. Making the storage component temperatures higher than the core will ensure that the hydrogen fills the core first. At the first indication of fission, the hydrogen transfer will be terminated. Stable and safe operation of the reactor requires that the chamber contain only enough hydrogen to bring the core up to criticality, leaving the storage media almost completely empty of hydrogen. The storage material must have the capacity to absorb massive volumes of hydrogen in the event of any over-temperature excursions of the core and therefore under normal conditions must be substantially empty. Stable operation of the module will require a minor surplus of hydrogen, which can be finely adjusted as the reactor starts power production. Periodic maintenance of this hydrogen reserve will be required to make up for the minor but continual loss of hydrogen to diffusion through the container walls. Such hydrogen addition is only to maintain the otherwise static and fixed quantity of hydrogen in the reactor and that addition, while occurring on a regular basis, is only performed on rare occasions.

Permanent shut down and safety from any further fission activity would reverse this process. Initial shut down would be accomplished by cooling the storage media. This would be made permanent by evacuating the hydrogen from the gas-confining chamber. Residual radioactivity stored in the core would normally be expected to keep the core temperature elevated, ensuring that the core would be emptied first of most of its hydrogen. The reactor is permanently safe from any possible fission activity as soon as enough hydrogen is extracted that what remains cannot moderate the core up to criticality. It should be very easy to extract almost all of the hydrogen in a reasonable length of time, easily satisfying this criterion many times over.

This hydrogen extraction can be accomplished at pressures above ambient by ensuring that the uranium powders are above 430° C. during the extraction procedure. The 430° C. temperature is the dissociation temperature for one atmosphere hydrogen pressure. The positive gauge pressure ensures that no oxygen can leak into the module and generate oxides of the fuel. After the hydrogen has been extracted, the module can then be pressurized with an inert gas (e.g., argon) to ensure a positive overpressure as the module is transported back to the factory.

Hydrogen Gas Maintenance

The hydrogen gas in the chamber needs to by maintained for purity and periodically supplemented to maintain the correct quantity and isotopic content. Access to the hydrogen gas is available by means of the gas ports diagramed in FIG. 1. The tubing leading from these ports can extend to the earth surface and facilities that are accessible to maintenance personnel. The hydrogen purity can be maintained by systems that either circulate a small fraction of the gas through appropriate filter systems or perform the same services in an oscillatory manner. The circulating system would actively pump the sample stream of hydrogen through a hydrogen permeable metal membrane. Impurity gases would not be able to pass through the membrane and would accumulate near to the membrane surface. The volume close to the membrane would be periodically sealed off and evacuated to permanently remove the impurities from the gas stream. An alternative system would employ a hydrogen absorbing material such as uranium hydride to selectively absorb hydrogen but not any impurities. Again, the impurities would accumulate near to the absorbing surface. As the absorber neared saturation the nearby region would be sealed off and the impurities evacuated as before. In the circulating system, the gas flow would be maintained by pumping it around, while the absorption/desorption system could be driven by temperature changes. In both systems, mechanical valves would be required to seal off the impurities for evacuation. Furthermore, in both cases redundant systems would be employed so they could operate out of phase with respect to each other so as to not adversely affect the hydrogen pressure in the reactor chamber.

Fuel Alternatives

This power module can accommodate a variety of fuel compositions. The initial calculations assumed 5% enriched “reactor grade” uranium. Additionally, the system design is based on the physical-chemical properties of uranium. Other combinations of fissile fuels mixed with fertile or non-fissile hydrides will also work.

For example, the U²³⁵ can be replaced with plutonium to serve as the fissile element. Plutonium reacts very rapidly with hydrogen making a hydride at room temperature with a very low dissociation pressure compared to uranium hydride. Plutonium's melting temperature is 640° C., which would make the hydride particles fuse together at temperatures that might be as low as 400° C. These low temperatures make PuH₃ much less attractive as a reactor fuel to power a steam generator. However, if plutonium is only a minor constituent, diluted by depleted or natural uranium, it will have only a minor effect on the properties of the combined hydride. At the pure uranium limit of the Pu—U phase diagram, the melting temperature of uranium is reduced approximately 11° C. per 1% of added Pu. A 5% substitution of Pu into metallic uranium only reduces the melting temperature 50° C. to 1075° C. This small change in transition temperature should affect the particle fusion temperature by an equal or less amount. The hydride formed by the mixture of U and Pu may therefore perform essentially identically to that of pure uranium. The possibility of substituting Pu for U²³⁵ in the power module significantly adds to its versatility and commercial attractiveness.

Plutonium produces less than half the fraction of delayed neutrons as uranium, which reduces the margin of safety for controlling the fission reactions if it is used in conventional reactors. Because this reactor is limited in criticality increase by the slow inflow of hydrogen through the powdered fuel, the reduced number of delayed neutrons may no longer be the dominant concern that it has been. As presented above, the variations in the neutron multiplier to keep the reactor stable have been at a maximum of the order of 10⁻⁴. Because the delayed neutrons coming out of plutonium is 0.003, there is a full order of magnitude margin of safety for the plutonium-burning reactor to be safe and stable. The hydride reactor may prove to be an effective device to burn plutonium, solving one of the nuclear industry's significant problems: what to do with the plutonium that has accumulated since the dawn of the nuclear era? This important niche could make this power module very important for the future of the nuclear industry.

Thorium hydride has physical-chemical properties similar to uranium hydride, but only for part of the hydrogens per molecule. The first two hydrogens bound to a thorium atom (ThH₂) are more tightly bound than the others, up to Th₄H₁₅. This results in a dissociation pressure for hydrogen compositions above ThH₂ that is similar to UH₃ but only a fraction of the hydrogens are mobile. Use of thorium hydride would result in greater physical disruption of the powdered fuel as hydrogen escapes to stabilize periods of positive reactivity and slow the return of hydrogen during periods of negative reactivity by increasing the thickness of the powder barrier through which the gas must be forcefully transported. Thorium could be used as the fertile diluent for either fissile uranium or plutonium. Because the transient calculations predict that less than one percent of the stored hydrogen need be exchanged to maintain criticality stability, the limit on the fraction of hydrogens in thorium hydride that are mobile should not present a significant difficulty. Thorium hydride may ultimately be even more attractive than uranium hydride because separating the fissile components from the fertile components would be a chemical separation instead of an isotopic separation. Furthermore, the fissile product of thorium absorption of a neutron is U²³³, which is a very attractive fissile fuel for reactors.

Thorium also permits higher temperature operation of the reactor because of its high melting temperature of 1755° C. The higher temperature operation offers the possibility of higher efficiency conversion of the thermal power generated by the reactor to electrical power. The high melting temperature would complicate the zone refining processing of the spent fuel; however, alloys of thorium and uranium would reduce the melting temperature. For a wide range of compositions on the uranium rich side of the phase diagram the melting point of the alloy is a fixed value of 1375° C. On the thorium rich side of the phase diagram, the melting temperature is approximately linear with thorium content from the 1375 to the 1755° C. point for compositions from 50 to 100% thorium.

High Fuel Burnup Performance

Many reactors purposely designed for high stability and particularly designed for unattended operation are constructed on the edge of criticality. The negative feedback that controls them is often either the thermal expansion of the core elements or the thermal heating of the neutrons to take advantage of a negative slope of the fission absorption cross section and the positive slope with energy of resonance absorption of the neutrons by competing nuclei. These devices usually are operationally marginal, assembled only a few percent over the critical mass achievable with the controls optimized. It therefore may not be possible to achieve more than a few percent burnup of the fuel in the reactor, at least without some mechanical adjustment of the system parameters. In contrast, the hydride reactor can maintain control of the fission activity for a large excess of fuel, which permits high burnup of the available fuel. Fissile fuel burnup of at least 50% should be achievable with adequate design. The critical parameters for the initial design of the reactor and the point where the reactor finally fails to reach nuclear criticality can be estimated using MCNP or from work detailed in H. C. Paxton et al's work (“Critical Dimensions of Systems Containing U²³⁵, Pu²³⁹, and U²³³”, Los Alamos Scientific Laboratory and Oak Ridge National Laboratory Report TID-7028 (June 1964)). To a first order approximation, a 50% burnup requires about twice the minimum amount of fuel and about one half the stoichiometric amount of hydrogen (protium) to achieve initial criticality.

Heat Extraction for Practical Applications

For operation in the 500-550° C. range, potassium is an effective working fluid for heat pipes for the invention. Power extraction requires a thermal gradient but this gradient must be controlled to prevent localized high temperatures that might fuse the powder particles together into larger clumps. The thermal conductivity of the hydride can be estimated from measurements made on hydride based SNAP fuels detailed in Sidney G. Nelson (“High-Temperature Thermal Properties of SNAP-10A Fuel Material”, Battelle Memorial Institute Report 1714 (1965)), which gave a conductivity of approximately 0.35 W/cm/° C. The hydrogen gas thermal conductivity is temperature dependent but approximately 1/100 of the hydride value. The combination thermal conductivity is then approximately 0.04 W/cm/° C., for the measured void fraction of 0.32. This thermal conductivity is small but is similar to the 0.05 W/cm/° C. conductivity of UO₂, commonly used in reactor fuel rods, in the same temperature range. Therefore the thermal management of a device according to the invention requires engineering similar to that already developed for present day power reactors. The optimization of the heat pipe geometry is, of course, an important engineering task to manage the temperature gradients for a particular embodiment of the invention. As has been discussed, those gradients must be limited to insure that the peak temperatures within the core do not exceed the high temperature limit that might initiate powder agglomeration.

Continuous Feed Reactor

The preferred nuclear power source of the invention is highly compact. This compact design has many advantages over present-day reactors. It is also possible to expand the size of a reactor based on the uranium hydride fuel and moderator to exploit additional advantages afforded by the properties of this fuel. A larger reactor can be fabricated by any technique that increases the critical mass and volume. The easiest and most advantageous of these include diluting the critical mass with an abundance of heat pipes and/or reducing the level of U²³⁵ enrichment. As this physical size increases, a point will be reached where it is no longer advantageous to ship the module back to the factory for refueling and refurbishment.

If a uranium hydride reactor becomes a fixed installation, the powdered nature of the fuel permits the module to be continuously fuelled. Powder can be added to the top of the core and an equal quantity can be extracted from the bottom. Because it is anticipated that the fuel cycle will be measured in years, the rate of material replacement is quite low. Therefore, although the fuel feed and bleed introduces additional complications into the mechanical design, these additions are minor because of the small quantities of material that must be handled at any time.

Fuel Reprocessing

One of the remarkable advantages of this reactor concept is the novelty of the fuel form. The hydride chemistry essentially does an end run around many of the problems of nuclear fuel reprocessing. At the end of the useful life of the original charge of fuel, the module will be returned to the factory containing an overpressure of inert gas and residual hydrogen. Adding heat to the fuel drives off any remaining hydrogen and leaves uranium metal. This metal can be stripped of its fission product contaminants by simple zone refining. It would be desirable to recycle all actinides so that the waste does not contain many long-lived components. The small fraction of the processed fuel that contains the concentrated waste may require further processing to extract residual actinides to be blended back into the fuel fraction. Reuse of the fuel would require blending in an add-mixture of enriched or otherwise fissile material to bring the fissile component up to the original 5%, reactor grade design level. This reprocessing only required the addition of power to process the fuel, thereby adding nothing new to the waste stream. The fission fragments can be further concentrated if it is economically useful or can be further processed to extract economically valuable radiation sources.

The simplicity of the process and the zone refining equipment makes reprocessing this fuel economically viable. This permits the contaminated but unburned fuel to be recycled, greatly reducing the waste stream and dramatically improving the economics of future nuclear power production. Only the fission fragments mixed with some residual uranium or thorium require permanent disposal.

Volume Enhancement by Deuterium Dilution

Diluting the hydrogen with deuterium may offer some advantages for the system design. The lower effectiveness of deuterium moderation may permit a slightly larger reactor core volume and therefore greater energy storage and operational lifetime of a single load of fuel. Mixtures of single and double atomic weight hydrogen may yield a fine-tuning tool for optimizing the control of individual reactors. Changing this ratio over the operational life of a reactor may be a future means for adapting the source to the poisoning effects of fission products, thereby extending the single fuel load operational lifetime.

Furthermore, manipulating the hydrogen isotopic ratio permits the hydrogen concentration to be kept close to saturation, while keeping the activity level constant, even during the periods when the reactor has significant surplus activity. Keeping the total hydrogen concentration nearly constant offers the advantage that there will be minimal expansion and contraction of the fuel over the lifetime of the fissile fraction. That, in turn, minimizes any potential structural stresses that might result from larger volume expansions. Therefore, occasional human intervention to adjust the ratio of deuterium to protium could improve the operational lifetime and stability of the reactor.

The foregoing description of the invention has been presented for purposes of illustration and description and is not intended to be exhaustive or to limit the invention to the precise form disclosed. Moreover many modifications and variations are possible in light of the above teaching.

All publications, patents, and patent applications cited in this specification are herein incorporated by reference as if each individual publication or patent application were specifically and individually indicated to be incorporated by reference.

I claim:

1. A nuclear fission reactor comprising
(a) a core open to an atmosphere containing a hydrogen or a hydrogen isotope material, said core consisting essentially of a powdered fissile metal hydride material that remains entirely within said core;
(b) a plurality of trays outside said core that store a non-fissile material thereon wherein said non-fissile material absorbs and desorbs said hydrogen isotope material based on said core's temperature;
(c) a means for heating and cooling said plurality of trays; and
(d) a means for extracting energy produced in said core.

2. The nuclear fission reactor of claim 1 wherein said powdered fissile metal hydride is fissile uranium hydride.

3. The nuclear fission reactor of claim 1 wherein said non-fissile material comprises a non-fissile uranium hydride.

4. The nuclear fission reactor of claim 1 wherein said core's temperature is between about 450 to 800° C.

5. The nuclear fission reactor of claim 4 wherein said core's temperature is between 500 to 550° C.

6. The nuclear fission reactor of claim 1 wherein said means for heating and cooling said plurality of trays is a plurality of elongated structures containing a nonhydrogenous fluid, said plurality of elongated structures extending outside said nuclear fission reactor.

7. The nuclear fission reactor of claim 6 wherein said nonhydrogenous fluid is a liquid metal.

8. The nuclear fission reactor of claim 7 wherein said liquid metal is potassium.

9. The nuclear fission reactor of claim 6 wherein said plurality of elongated structures is a plurality of fluid conducting tubes.

10. The nuclear fission reactor of claim 9 said plurality of fluid conducting tubes is a plurality of horizontal heat pipes.

11. The nuclear fission reactor of claim 1 wherein said means for extracting energy produced in said core is a plurality of elongated structures containing a nonhydrogenous fluid dispersed within said core.

12. The nuclear fission reactor of claim 11 wherein said nonhydrogenous fluid is a liquid metal.

13. The nuclear fission reactor of claim 12 wherein said liquid metal is potassium.

14. The nuclear fission reactor of claim 11 wherein said plurality of elongated structures is a plurality of fluid conducting tubes.

15. The nuclear fission reactor of claim 14 wherein said plurality of fluid conducting tubes is a plurality of vertical heat pipes.

16. The nuclear fission reactor of claim 1 additionally comprising an insulator located between said core and said plurality of trays adapted for dampening thermal feedback and reducing neutron leakage out of said core.

17. The nuclear fission reactor of claim 1 additionally comprising a containment vessel encapsulating said core and said plurality of trays.

18. The nuclear fission reactor of claim 17 wherein said containment vessel includes a plurality of gas ports.
